(19) United States
(12) Patent Application Publication
(10) Pub. No.: US 2011/0131106 A1
(43) Pub. Date: Jun. 2, 2011

(54) USING SOCIAL NETWORK AND TRANSACTION INFORMATION

(76) Inventors: George Eberstadt, New York, NY (US); Karen McGrane, New York, NY (US)

(21) Appl. No.: 12/629,520

(22) Filed: Dec. 2, 2009

(51) Int. Cl. G06Q 30/00; G06Q 99/00

(52) U.S. Cl. 705/26.1; 705/319

(57) ABSTRACT

Among other things, a user, who is engaged in a commercial activity on a commercial online site, is exposed to computer-stored information that (a) is associated with another user of the online site, (b) would otherwise be private to the other user, (c) relates to the commercial activity of the user, and (d) is controlled by the site.

This application relates to U.S. patent application serial 12/098,618, filed Apr. 7, 2008, which is a continuation-in-part of U.S. patent application Ser. No. 12/026,972, filed Feb. 6, 2008, which is a continuation-in-part of U.S. patent application Ser. No. 11/968,431, filed Jan. 2, 2008, and to PCT application PCT/US 2008/087943, all incorporated here by reference in their entirety (the incorporated patent applications).

### BACKGROUND

This description relates to using social network (SN) and transaction information.

As explained in the incorporated patent applications, SN information includes, for example, information about connections between people, and demographic and other information about the people who are the subject of the connections. Information about real life connections among people may be stored in a database (also called a who-knows-whom database, a SN graph, or a SN database) in which each person (and the demographic and other information—for example an email address and an assigned unique identifier—about the person) can be represented in a node and the connections among people can be represented by connections that join nodes.

SN databases are created and maintained by SN sites, for example, Facebook or LinkedIn. The node information and the connection information of the database can be derived directly from the users of a SN site through a user interface of the site (for example, when the user first registers or adds information later) or may be inferred from actions of users on the site, or may be obtained from other sources. For example, a separate site that sells shoes may provide to the host of a SN site a list of products purchased by people who are users of the SN site. The SN site may then, for example, display this information in association with other information about a “target” user, when an interested user of the SN site is viewing information about the target user. For example, if Bill is viewing Carol's profile on Facebook, he could be presented with a list of products that Carol has recently bought.

Although a site may have a primary function other than maintaining a SN, such as retail sales, the site also may generate and maintain a proprietary SN database about its customers. The proprietary SN database may include node information and connection information that is derived explicitly or implicitly from the customers as they register as users of the site, maintain their user profiles on the site, and use the site for its main purpose. Such a site may use the proprietary SN database to enhance the experience of its users and improve the sales or other performance of the site.

Users who want to participate in the proprietary SN databases of multiple sites may register separately for each of them by providing demographic and personal information (including an email address) and defining connections they have with other people who are users of the site. To complete the creation of the connections for each of the proprietary SN databases, the other people whom they have identified are asked to verify and consent to the inclusion of the connection information in the database.

A SN site may make its SN database available to other parties who may develop applications to use the SN information. These applications are installed by the users on both sides of a connection defined by the SN database in order for the SN aspects of the applications to be usable.

### SUMMARY

In general, in an aspect, a user, who is engaged in a commercial activity on a commercial online site, is exposed to computer-stored information that (a) is associated with another user of the online site, (b) would otherwise be private to the other user, (c) relates to the commercial activity of the user, and (d) is controlled by the site.

Implementations may include one or more of the following features. The user who is engaged in the commercial activity and the other user are known to have a connection with one another. The commercial activity includes shopping for a product or service. The information includes information about activities of the other user on the online site. The information includes information about a product or service bought by the other user on the site. The information comprises information about purchases at the site by users of the site. An interaction is facilitated between the user who is engaged in the commercial activity and the other user. The facilitating includes initially displaying some of the information without any information that is private information of the other user. The facilitating comprises serving as a conduit for a question of the user directed to the other user, and for an answer of the other user. The facilitating is assisted by a third party social networking system. The information includes a recommendation of the other user. The user and the other user are connected through a social networking site. The connection of the user and the other user is determined by information provided by the user, the other user, or both. A connection between the user and the other user is identified based on identifiers associated with at least one of the users, and selecting information to be exposed, based on the identified connection. The other user has given permission to the exposing of the information to the user who is engaged in the commercial activity. The information that is exposed to the user is a selected subset of available information that could be exposed to the user. The information that is exposed is organized by a product item or a product category.

In general in an aspect, an online inquiry is received from a user who is contemplating a transaction on an online site. One or more other users of the online site are identified to whom to direct the inquiry, based on stored information about other transactions that have occurred on the online site.

Implementations may include one or more of the following features. Data is obtained (from the stored transaction information) that enables the online inquiry to be sent to the other users. The stored information about other transactions is controlled by the online site. The online inquiry relates to a product that the user is contemplating buying, and at least some of the other transactions include transactions that relate to the product that the user is contemplating buying. The user and the one or more other users are friends in a social networking system. A response to the inquiry is obtained from one or more of the other users, and the responses are exposed to the user who is contemplating the transaction.

These and other aspects and features, and combinations of them, can be expressed as methods, apparatus, systems, components, program products, methods of doing business, means for performing functions or steps, and in other ways.

Other aspects and features will become apparent from the following description and the claims.

### DESCRIPTION

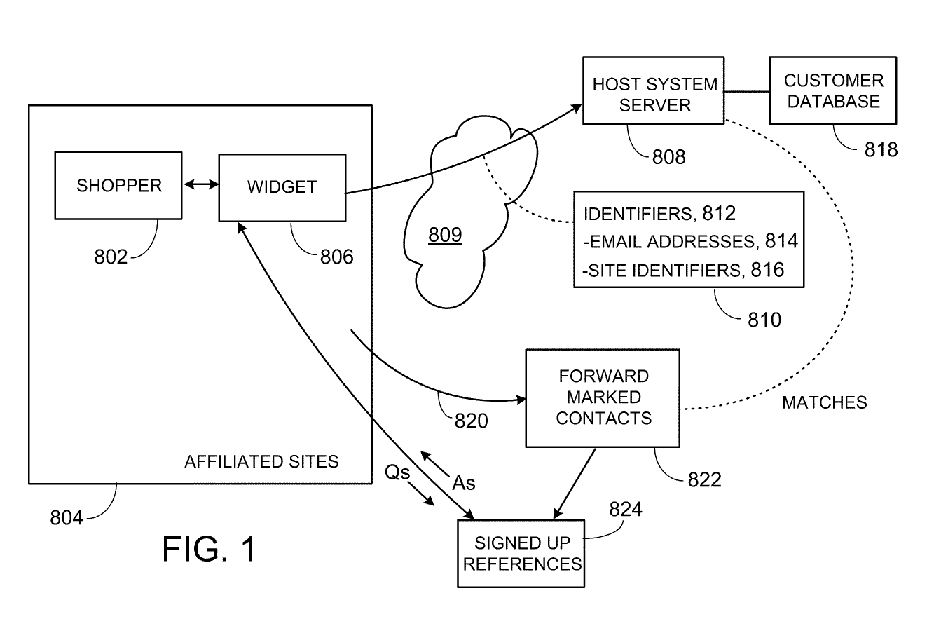

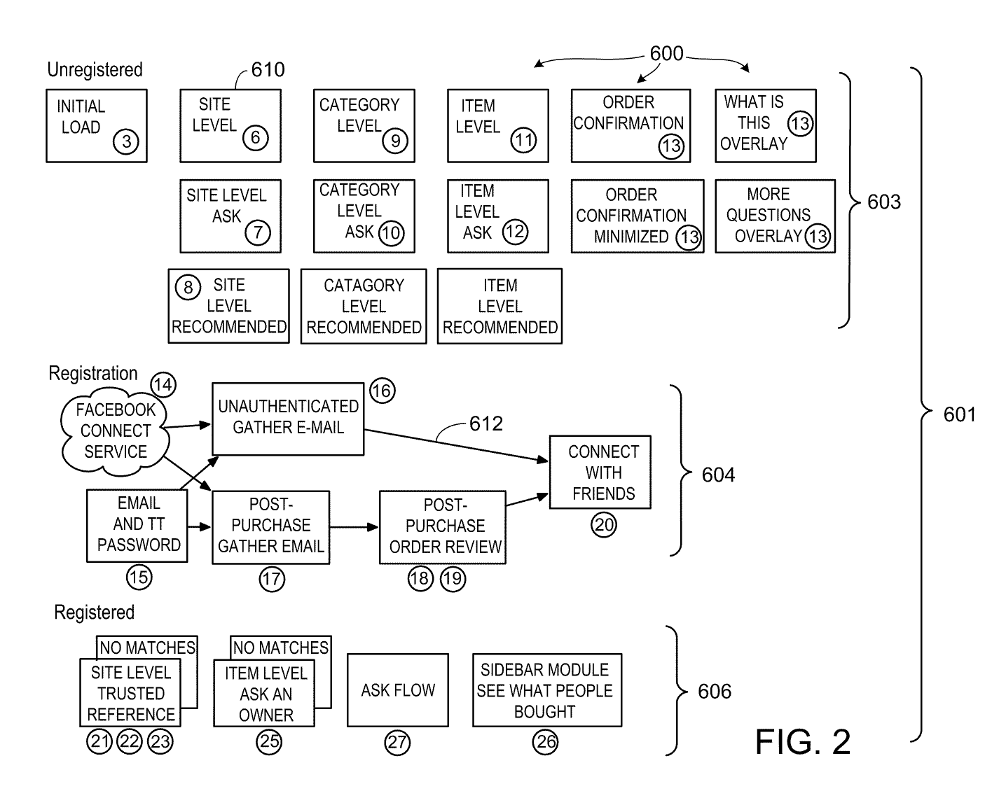

FIGS. 1 and 2 are block diagrams.

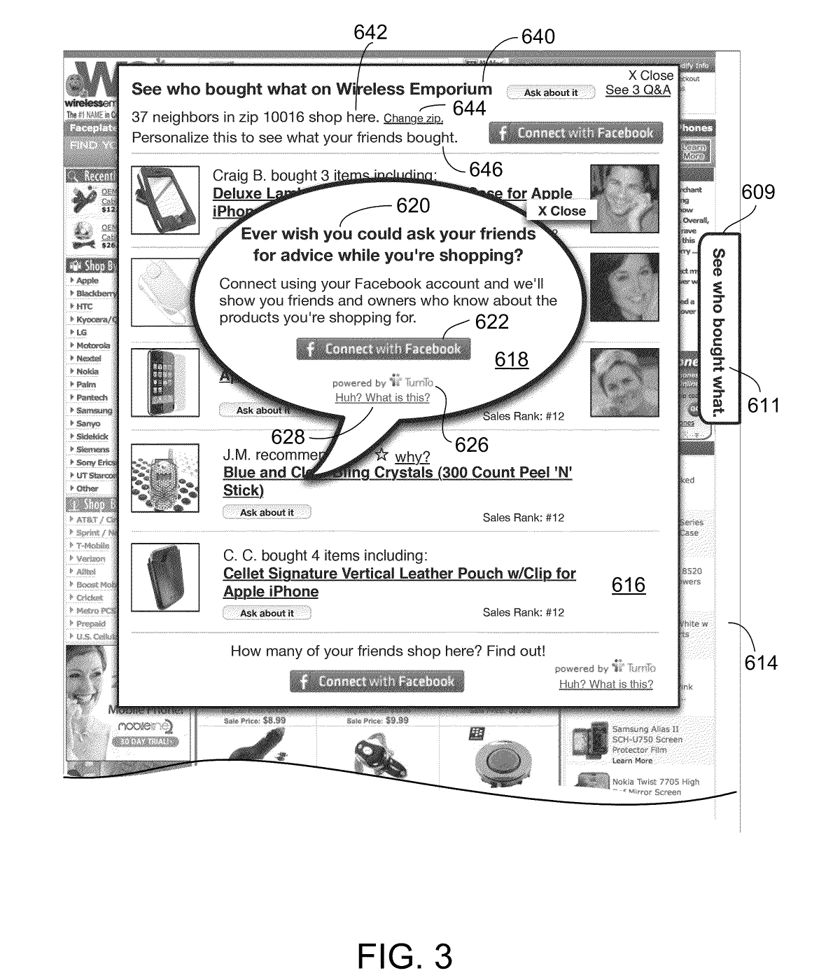

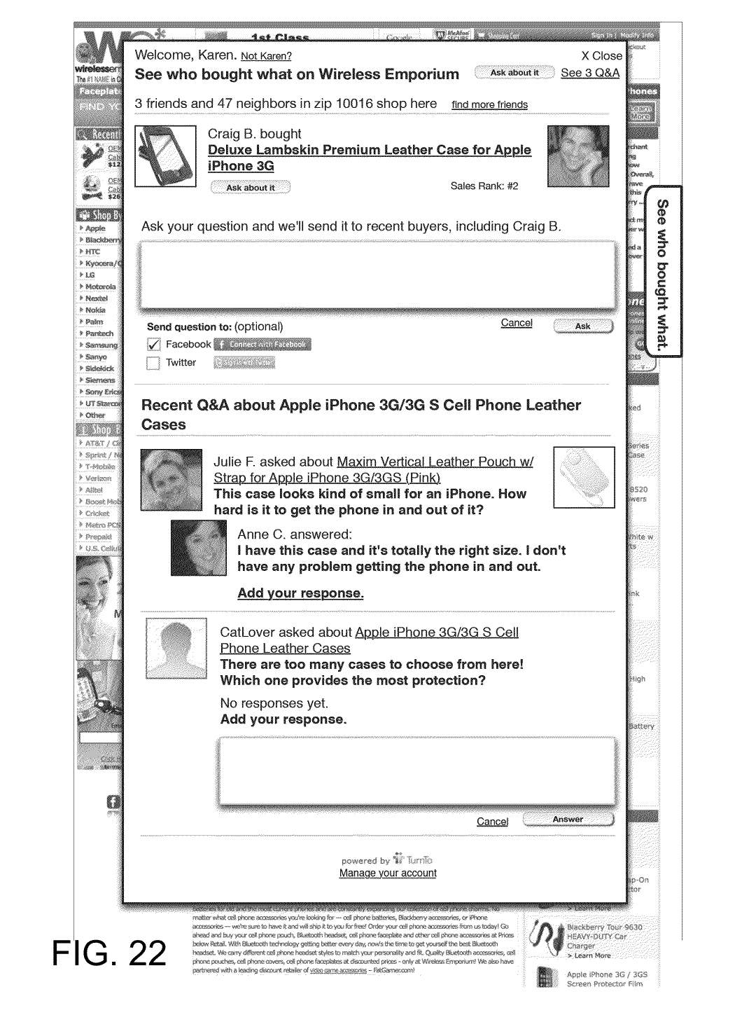

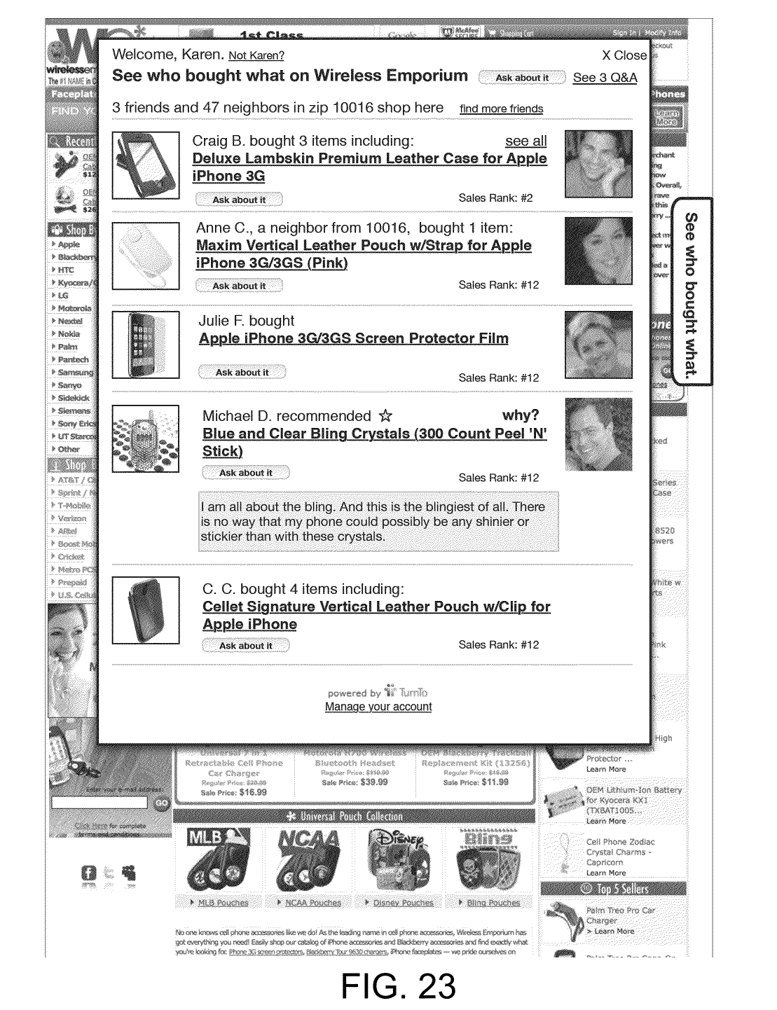

FIGS. 3 through 27 show user interface elements.

As explained and illustrated in the incorporated patent applications, a shared SN system may, among other things, receive, create, aggregate, supplement, organize, maintain, use, make accessible, and distribute SN information in a shared SN repository. The shared information includes, among other things, node information and connection information about users. Users of the shared SN system and users of a wide variety (and potentially a very large number) of other sites (e.g., sites that have subscribed to services provided by or have otherwise become affiliates of the shared system) are able to submit, maintain, update, release, and provide permissions, authorizations, and other controls at a single shared SN repository.

Users of the shared SN system and of sites may then use proprietary or open features and applications that are running at each of the sites or combinations of them and that are designed to rely on and take advantage of the SN information of the users (and information about the users and others stored in the shared SN repository and at other sites that have subscribed to or made other arrangements to use and/or contribute to all or part of the shared SN repository). The features and applications of the sites may be ones that the users already use (for example, retail sites, portals, SN sites, and others), or ones that the users begin to use after having become users of the shared SN system.

We use the term sites extremely broadly to include any on-line or non-online capability, service, facility, resource, feature, or application that can make use of the SN information stored in the shared repository in any way. Many examples of such sites operate using content of a wide variety of kinds Sites include websites of all different types, including portals, commercial sites, individual sites, internal sites of enterprises, and all of the types of content that they support, including applications, audio, video, images, catalogs, and accounts to name a few. Sites may be relatively static or relatively dynamic, such as publications, blogs, review sites, photo, video, and audio sites, user-generated content sites, location information, mapping sites, and other kinds of content sites, among others. Static sites can be of the kind typically used for business to business marketing collateral and non-retail transactional sites (e.g., B2B transactions and client relationships that may not be naturally characterized as a “transaction”). Chat facilities, groups, instant messaging, emailing, and other forms of content based communication fit within the concept of sites.

In general, sites enable users to engage in activities, which we use in its broadest sense. Activities may include, for example, money-based transactions such as retail, wholesale, and business sales activities, investments, and financial instruments, and also non-money-based activities such as bartering, exchanging of information, registration, submission of content, borrowing, lending, and any other kind of exchange or passing of content or value from one party to another or among multiple parties, to name a few. Activities need not involve a bargain or exchange but could also involve, for example, an activity of a user with respect to content that may be available at the site. This could include submitting, updating, modifying, or removing content; searching, sorting, downloading, displaying, presenting, or retrieving content; participating in a group activity as an observer, a player, a critic, or a recipient; registering, signing in, accepting, withdrawing, or terminating rights, participation, membership, or accounts. These are only examples and the term activity is used in an extremely broad sense.

Sites may be present at any location, for example, on servers, on personal work stations, on portable devices, and at other places. Access to sites may occur through any communication channel, such as wired or wireless channels using any kind of communication infrastructure such as the Internet, intranets, dial up communication, dedicated and private networks and the like.

The repository can be part of a server hosted by a party that serves as a clearinghouse, broker, or medium for shared SN and other information derived from many sources and made available to many sites. The server may host a wide variety of other applications that enable it to perform the services and functions described here, and many others. Access to the shared repository and the applications in the server can be made through any communication channel of any kind, including, in some implementations, networks such as the Internet.

The shared SN repository can be created and maintained “once” without duplication of effort and then used by many sites (and users of the shared system and of other sites) in many ways and at many times. Because the users need only register (and provide other SN information) in one place to have their SN information available (with permission) at a large number of sites, they are freed from the need to register and maintain their node information and connection information redundantly at many different sites. This feature significantly increases the chances that users will participate in the shared system. Because users are more likely to participate, the system substantially increases the opportunities for independent sites to create applications that take advantage of the information contained in the shared repository with a reasonable expectation of participation by a large number of users.

As the size, extent, complexity, and completeness of the shared SN system grows, its value to other sites and to users grows.

Other sites that wish to use SN information are able to access, and make a wide variety of uses of the shared SN repository or portions of it, available at a single, convenient location reducing or eliminating the need for the site operator to convince its users to build their social networks within the site. The sites can be completely flexible in how they use the shared SN repository information to best suit their business model and functions and the expectations of their users. Sites can combine all or part of the shared SN repository information with their own user information (for example, SN information about their users, and non-SN information related to their users) for use by their applications. An application development toolkit can be provided to the facilities to simplify their development and integration of such applications.

A variety of business models can be used to finance the shared system 100 and to generate revenue from it. In some models, in order to build the shared SN repository to a significant size quickly, the database and tool kit may be provided to affiliated sites at no charge or a small charge for an initial period of time to encourage those sites to adopt applications that will make use of the shared SN system. Later, a monthly or annual license fee may be charged to the affiliated sites for continued access. A wide variety of revenue models can be used to define the license fees, including licenses based on volume of use, number of transactions, revenue associated with the use, time-based charges, and others. Sometimes we refer to sites that are making use of information in the shared SN repository as affiliates or affiliated sites of the shared SN repository. Affiliates can include sites, other online devices, applications, features, and other entities and enterprises. Typically an affiliate has access to information in the shared SN repository by virtue of an agreement, license, course of dealing, or other authorization.

Other sources of revenue in some business models can include, for example, license fees from advertisers for uses of the shared SN repository, and development by the operator of the shared SN repository of applications that leverage the repository to generate advertising or usage revenues.

It also may be possible to derive other revenue streams from the users of the system 100, for example, by providing premium services associated with the use of the shared SN system or by enabling access by paying users to facilities that are otherwise restricted.

Important features of the shared system include (but are not limited to) the following:

1. The system serves as a builder, clearinghouse, intermediary, and broker for information in the shared SN repository. Other sites (and other parties, including advertisers, manufacturers, distributors, and financial institutions, for example) can make use of the information in the shared repository as the basis of valuable and useful applications and features. Users of the shared system agree in advance to permit information about them that is in the shared repository (and, in some cases, would otherwise be considered confidential) to be communicated from the system to the other sites. The other sites, which are typically controlled independently from the shared system) control the sharing of that information, consistent with permissions given by the users to whom the information belongs, with people with whom the users are connected (according to the connection information in the shared repository). We sometimes refer to people with whom a user is connected simply as the user's connections. The display of the information about the users of the shared SN repository, to users of the other sites is done through the other sites. Each site can store some or all of the information from the shared repository in its own repository, combine it in any way it considers useful with its own information about its own users and other users, and decide how, when, where, in what manner, and under what conditions to display the information to its users. Arrangements are made between applications running on the shared system and applications running on the other sites to assure compliance with the permissions, and to facilitate a potentially large number and wide range of other features between the shared system and the affiliate sites.

2. Information associated with people with whom a user has connections, according, for example, to the shared SN repository, can be displayed by (or the user can be given access in other ways to the information by or from) a site in connection with a transaction or any other activity in which the user of that site is engaging. Thus, the display of the information about the user's connection is not triggered merely when the user specifically indicates an interest in the information about the connection, or users having similar characteristics, or based on selected types of connections (for example, “show me all of the people with whom I have connections and who graduated from the same college as I”). Rather the display (or other giving of access) can be determined on the basis of, in the context of, and at the time when the user is working on a transaction or other activity. For example, if the user has added red wool pants to his shopping cart on the Lands End site, then in conjunction with that proposed purchase, and without further action by the user, information about his connections that may relate to the purchase (for example, his friends who have also bought pants from Lands End) are displayed to the initiating user.

We use the term display to refer broadly to any way in which the information can be exposed or presented to the user (or by which the user may be given any kind of access), for example, by display on a computer monitor, but also on any other device, or by presentation of sounds, video, images, text, applications, or any other content or manner of providing it. Display can also refer to making the information accessible to a user for pickup at another location, for searching, or for downloading in any manner, to name a few examples. Any manner in which the user is aware of the progress or nature of a transaction or activity (in the broadest sense) may be a form of “display”.

3. A user of the system can control the character and level of his relationship with his connections in a complex and finely grained way for later control of how the information about him is used and displayed to others. The user is not limited merely to indicating that he and the other person are “connected” or “not connected”. For example, a user may specify that he knows another user and the other user is therefore a connection, yet the first user can control the extent to which (for example, the time, place, context, frequency, conditions, purpose, and other parameters for which) his information in the shared repository may be displayed (or otherwise made accessible) to the other user. For example, the user could set a permission requirement for his confidential information that would require “ask me” permission on a particular site or other facility before his information could be provided to any of his connections.

Based on this flexible permission arrangement, a user may be able to see, in connection with his use of a facility, things he has in common with people to whom he has a connection, such as when he has purchased (or is considering purchasing) the same item, has traveled to the same place, knows the same people, or is located near the other person. The applications running on the site could include, for example, ones that enable a person to play games and have contests with people with whom he has things in common, enable users to share information about themselves with their connections while restricting access by others; allow communications between two users to be shared exclusively with their connections (for example, “shouts” and “walls” and “endorsements” . . . ); and be used to permit third parties (e.g., sites, businesses) that have user information that would otherwise be considered private to share that information with a user's connections.

In some implementations, a system widget is provided that includes application code that provides functionality to the affiliate sites using information and services provided by the system server and, in some cases, by the affiliate site or application or other sites or applications. The modules of the system widget include a system application that exposes the functionality of the shared system to the user of the affiliate site or application or feature. The shared system can provide affiliates with application templates, which they may use in the form provided or may modify if required, to create applications. A matching engine compares user IDs provided by the system server to user IDs provided by the affiliate application or site that is making use of the system application and returns matches to the system application, according to rules specified by the system application.

The system widget may provide connection facilities to simplify the retrieval of information from the affiliate applications or sites from which information is to be obtained to support the functions of the system application. The affiliate site or application is a site or application at which users may access the functionality of the system application (some functionality can be accessed by users directly through the system website).

The system widget may provide connection facilities to simplify the retrieval of information from the affiliate applications or sites from which information is to be obtained to support the functions of the system application. The affiliate site or application can be a site or application at which users may access the functionality of the system application (some functionality can be accessed by users directly through the system.com site).

The system widget may use information obtained from applications or sites of the affiliate or from other sources.

To take advantage of SN features on typical sites, each user must identify his SN connections by separate steps on each site. When the user signs up on another site, the user's SN connections must be re-identified to the new site. The repeated identification of SN connections can create a tangle of connections that sometimes may be incomplete or time consuming to re-identify.

Thus, considered at a higher level of abstraction, the shared SN system serves as an aggregation system for users' SN information, enabling them to maintain this information in a single place and to use features and applications that take advantage of the information at a large number of affiliate sites that subscribe to the shared SN system, including affiliate sites that the users already use.

An important feature of the shared system is the shared SN repository. This independent electronic database of SN relationships of a user can include the profiles of the system members, their connections to other system members, and their privacy (and permission) preferences with respect to their connections and to the affiliate sites. The database design can be structured to provide affiliate sites with the information they need to effectively tailor the social experiences they provide to the needs and expectations of their users while recognizing that different sites will need different types of information and also meeting the needs of system users for simplicity and speed.

Here we describe, as examples of broad concepts, how to determine which people (called, for convenience, “references,” without limiting the breadth of the term “people”) will have their identities and transactions on an affiliate's site available to be shown to someone who, for example, is (a) a current user of the site (sometimes called, for convenience, a “shopper” without limiting the breadth of the phrase “current user of the site,”), and (b) also a member of a SN site, for example, the shared SN system.

We sometimes below refer to a shared SN system as a host system—an example of such a shared SN system or host system is TurnTo™, which is accessible at www.turnto.com on the World Wide Web).

One way to identify such references, described earlier, can be called “reverse matching” and works as follows.

When the current user (the shopper) registers to become a member of the host system (often prior to the current shopping session), the user provides information about her contacts, for example, by uploading lists of identifiers (e.g., email addresses or unique identifiers used by social networking sites, such as Facebook) for those contacts. In the course of registration, the registering user agrees to allow those contacts to see purchases of the registered user made at affiliated sites of the host system, for example, when those contacts are shopping (we use the activity of “shopping” here only as a non-limiting example) at those sites.

One of the registered user's contacts who is using (e.g., is a shopper at) one of the affiliated sites may identify himself to the widget of the host system (which is running on the affiliated site) using an identifier such as his email address or his identifier on a social networking site, for example. The host system can then reverse match the entered identifier against identifiers that have been stored for all of the people contained in the database of the host system to find the shopper's contacts, people who could be possible references. The resulting list of references who are contacts of the shopper can then be used to fetch transaction information, from the affiliated site's data, about transactions of the references, for display to the shopper.

With reverse matching, the matches may be limited to contacts who were previously entered by users of the host system. Yet the proportion of all shoppers of an affiliated site who are registered users of the host system and therefore can be reverse matched as references for other shoppers on that site may be relatively small. The experience for shoppers on such a site could be substantially enhanced if transaction information for a higher proportion of the customers of that affiliated site could be used.

To do that, the host system widget can be set up also to identify all contacts of the shopper who have also shopped at the site, using what we call “forward matching.” In this way, the transaction information that can be shown to a shopper is not limited to references who had previously identified the shopper as a contact.

As shown in FIG. 1, in some implementations, a shopper 802 on an affiliated site 804 may interact with the host system widget 806, to upload to the host system server 808 though a network 809, information about his friends and other contacts 810, including various identifiers 812, such as email addresses 814 and social networking site identifiers 816. The server checks (matches) those identifiers against identifiers (e.g., email addresses) of people that are stored in the entire customer database 818 of the affiliated site, whether or not those people have previously registered with the host system. This forward matching can yield a much higher proportion of matching references than would reverse matching. Additional matching can be done to find contacts of contacts of the shopper provided that the intermediate contact is a member of the system.

Without permission granted by each of the references, however, the transaction information of those other shoppers at that site should not yet be shown to the current shopper (for privacy reasons). The forward-matched references have not yet registered as participants in the host system or agreed to let friends and other contacts see their purchases. To entice the shopper to ask to see more, the host system widget displays to the shopper the existence of matching references (but in a way that does not compromise private information at this stage) and their purchases.

The host system widget facilitates the registration by those references and/or enables the shopper to ask the affiliated site (or the system server on behalf of the affiliated site) to send messages (e.g., emails 820) on the shopper's behalf to the forward-matched contacts 822 requesting that they reveal themselves to the shopper, i.e., agree to be references. Each email contains a link that takes the forward-matched contact to a page on the affiliated site where the contact can sign up to be a trusted reference. If the forward-matched contact signs up, the server generates an email to the requesting shopper alerting him that the sign-up contact is now available as a reference. In some implementations, once a forward-matched contact becomes a reference, only people on his contact list can see his identity and his purchases.

In some implementations, it may be possible to eliminate reverse matching altogether as a way to identify available references and to rely solely on such forward matching.

In whatever way the references are identified and consent to participation, it is possible to supplement the features provided by the host system widget to enable the shopper to ask questions of the references and for the references to give answers. In some examples, we call this feature “ask an owner”, because once the reference has been identified as an owner of the same or similar products as the one being considered by the shopper, or at least as someone who has shopped at that store before, the shopper can pose a question that can be answered by the reference.

More broadly, a wide range of possible interactions between the shopper and references can be facilitated either by the site or by the widget, not limited to asking and answering specific product questions. The interactions could include discussions, texting, instant messaging, and other forms of communications, postings of images or videos for viewing, passing of hyperlinks and attachments to messages, for example. The information that is the subject of such communications need not be limited to transaction information.

Once references have been identified and given permissions, however, not all transaction information for each of the references nor all identified references need to be the subject of information displayed back to a shopper. In fact, displaying all of the information could be distracting. Instead, a selection of information can be provided. Furthermore, a wide variety of choices can be made of which kinds of information is shared or displayed, the volume and timing of the displays, and other features.

In some implementations, a goal is to show the shopper a handful of recent customers of the site, and their purchases. This helps the shopper by humanizing the shopping experience and by providing useful information. It also helps the affiliated site by improving the shopping experience and encouraging the shopper to consider buying other products.

Choosing which references and which transactions to show can be done algorithmically at the server, for example, by assigning points to attributes of the transactions in the references, scoring a transaction and the references based on the points, and then displaying information tied to the highest ranking references and/or transactions. A very wide variety of attributes and ranking systems could be used.

For example, points could be awarded to a transaction based on attributes that include how recent the transaction is, how large, whether it relates to items that the affiliated site wants to promote, or whether the transaction is of a customer who has signed up to be a reference, lives near the shopper, or is a repeat buyer, for example. All of these attributes can be assigned points without the server having any registration or contact information from the shopper.

But if the shopper provides a contact or friend list, then the server can factor that into the algorithm. More points could be awarded if the reference customer is a first-degree friend of the shopper, fewer points if the shopper and the references are friends-of-friends, and fewer if they are related only by being in the same groups or networks.

When information about other customers or references and their transactions is displayed the shopper, if the people shown are not signed-up as references, their identities can be shown anonymously, and if they are signed-up references, they can be shown with a name (and photo, if available).

Unlike reverse matching, in forward matching, the contact list of the reference is no longer relevant to matching, only the contact or friend list of the shopper. Becoming a signed-up reference in a forward-matching system can mean, in essence, doing something (or taking any of a wide variety of actions) to confirm that “I am willing to have anyone who claims to be my friend or contact (e.g., as evidenced by having my email or being connected to me on a social networking site), see who I am and information about my transaction.” Other approaches are also possible. The scope of the permissions could be limited or defined in other ways with respect to the information that could be displayed and when, how, and to whom it could be displayed, for example. Different permissions could be of different scopes, selected by the person giving the permission, or imposed by the system or by the affiliate sites.

For the question and answer feature mentioned earlier, the shopper's question need not be directed to a named or specific reference. The server can determine which reference or references to whom to send the question by email. The determination can be made algorithmically taking into account similar attributes to those mentioned earlier. In addition, consideration can be given to how many questions each reference received in the past, whether she answered them, and how quickly. In some implementations, a target reference who is not registered as a participant in the host system, and who agrees to answer questions, can be required to register (sign up) as part of the process of answering. Questions can be delivered by other means than email, like IM or text messages to mobile devices. If such communication channels provide presence awareness, then presence can be considered as a factor in the choice of recipient for a question.

In a broader sense, a host system could be operated in a way to derive information about people's social connections not only from information that they provide directly, but also from information that can be derived from third-party sources. And information about a commonality of website activities engaged in by different people could be accumulated, or may already be available at a wide variety of sites, not limited to merchant sites commercial retail sites. By obtaining and cross-referencing the two bodies of information it may be possible to trigger exchanges of information and interaction among connected people in the context of their engaging in similar kinds of activities.

A very wide variety of implementations of forward matching and question-and-answer features are possible, including the specific examples described below.

For example, FIG. 2 shows three groupings 601 of various states 600 of a system widget 806 that runs on an affiliated site. The three groupings relate to contexts involving respectively activities of an unregistered user 602, a registration process 604, and activities of a registered user 606. Each of the boxes 610 corresponds to at least one other figure that illustrates a screen shot seen by the user when the widget is in that state. In some cases, arrows 612 are used to indicate flow between states. Each of the boxes 610 on FIG. 2 is annotated (using circled numbers) to identify other figures that are associated with the state represented by the box.

As shown in FIG. 3, when a user who is not registered with the host system enters a website 614 of an affiliate, the system widget undergoes an initial load. The initial load results in presentation of a small overlay 609 along an edge of the page on the affiliate's webpage, which contains a link 611 that bears a caption “see who bought what.” The overlay 609 and its caption 611 remain visible throughout the user's session at the website. At any time, if the user invokes the link 611, a overlay box 616 appears that contains a list of related transactions of friends or contacts of the unregistered user and/or other owners of products that the user is interested in.

A callout 618, overlaid on the box 616, contains a message 620 that alerts the unregistered user to a feature of the host system. The feature offers the possibility of getting information about the user's friends or other people who, for example, own products that relate to products that are of interest to the un-registered user (the shopper). The information that could be made available to the shopper could include the identities of those friends or other people, answers to questions, and other kinds of advice, among other things.

The callout 618 also has a link 622 that invites the unregistered user to connect to a social networking site (in this case, Facebook) which will enable the shopper, in effect, to sign up for the feature described above, namely to have shown to him information associated with friends or other contacts of the shopper who, for example, own or know something about the products and/or associated with owners of the products, whether or not those owners are friends of the user. The link 622 is essentially an invitation to the shopper to sign up to be able to get information and ask questions of others and also to be willing to answer questions for others, for example, with respect to products.

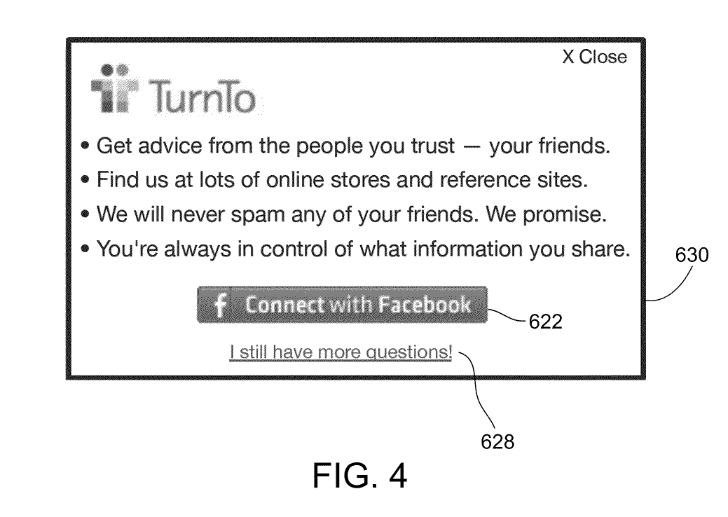

The callout 618 also contains a notation 626 that the service is made available by the host of the system that provides the widget (in this case, TurnTo), and a link 628 that takes the user to an informational overlay 630, shown in FIG. 4. The overlay 630 provides introductory information about the host of the system, repeats the link 622, and offers another link 628 that enables the user to get more information.

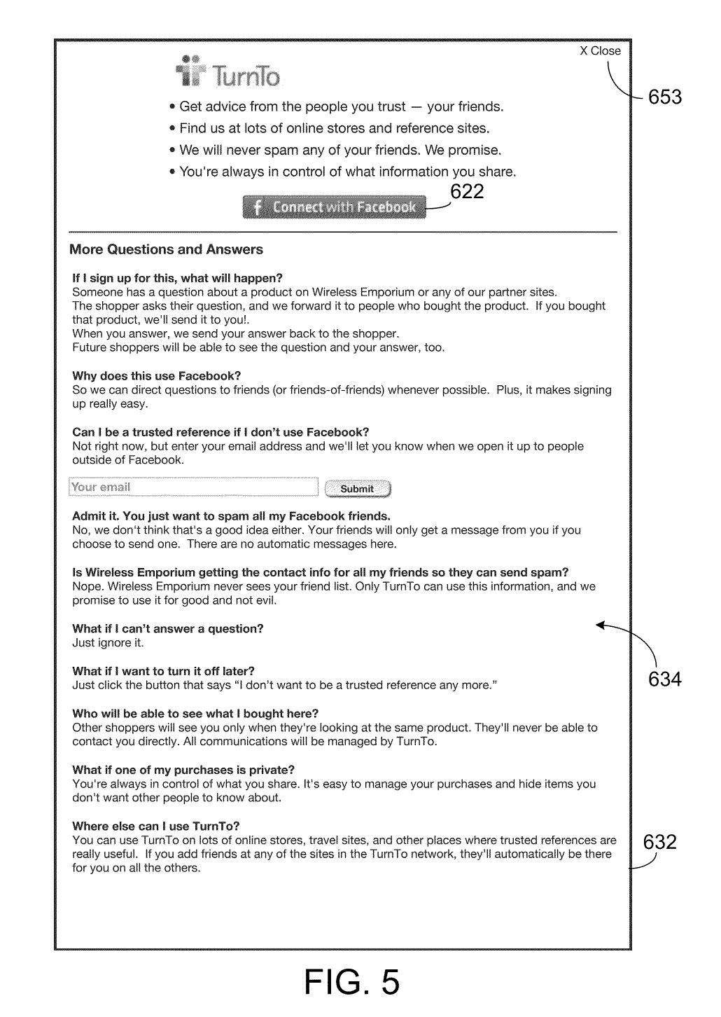

When the user invokes link 628, an additional overlay 632 is displayed as shown in FIG. 5. The overlay 632 repeats the link 622 as well as a series of questions and answers 634.

Each of the overlays shown in the various figures discussed here includes a “close” button 633 in the upper right corner which causes the overlay to disappear when invoked.

Referring again to FIG. 3, the overlay box 616 also contains an alert 640 to the user about the possibility of seeing who bought what on the website. An entry 642 notes for the user the number of people in a ZIP code related to the user's location, how many people shop at the website. A link 644 allows the user to change the ZIP code. An entry 646 points out to the user that, instead of merely seeing purchase information for other people some of whom may not be connected to the user, the user can cause the system to display products bought by the user's friends. Copies of the link 622 are presented in multiple places on the overlays.

Individual entries 648 on overlay box 616 report recommendations and purchases of other users and/or owners. A picture 650 of each product is shown at the left of each entry. And, for some entries, pictures of the owners or other users are shown on the right. Buttons 652 bearing the caption “ask about it” enable the user, who has registered, to ask for advice about the product.

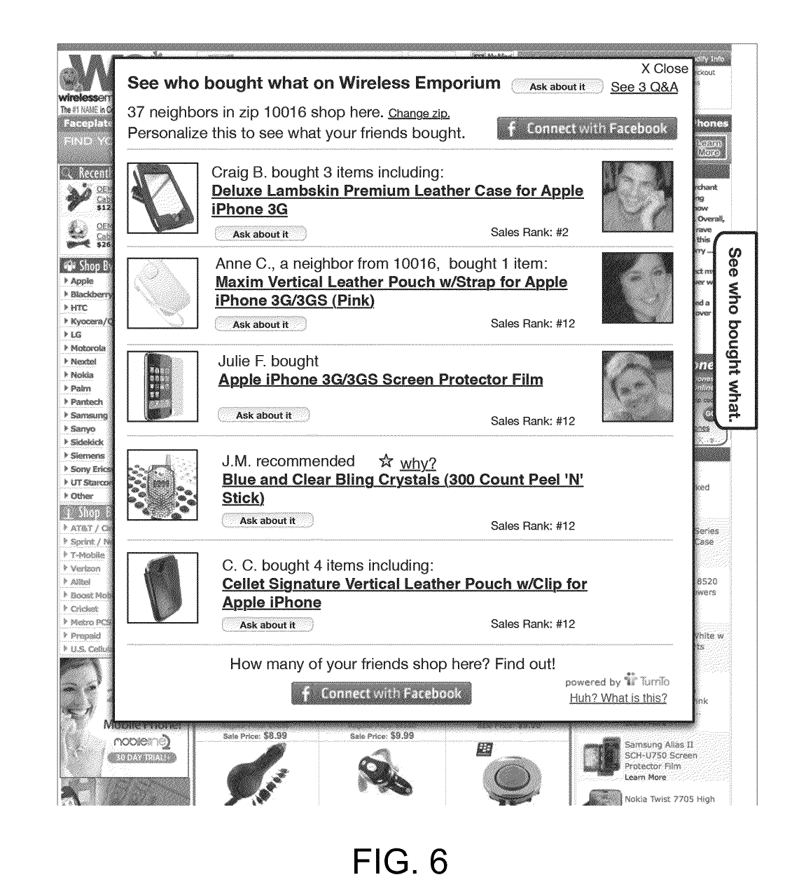

FIG. 6 is like FIG. 5, but with the callout 618 closed.

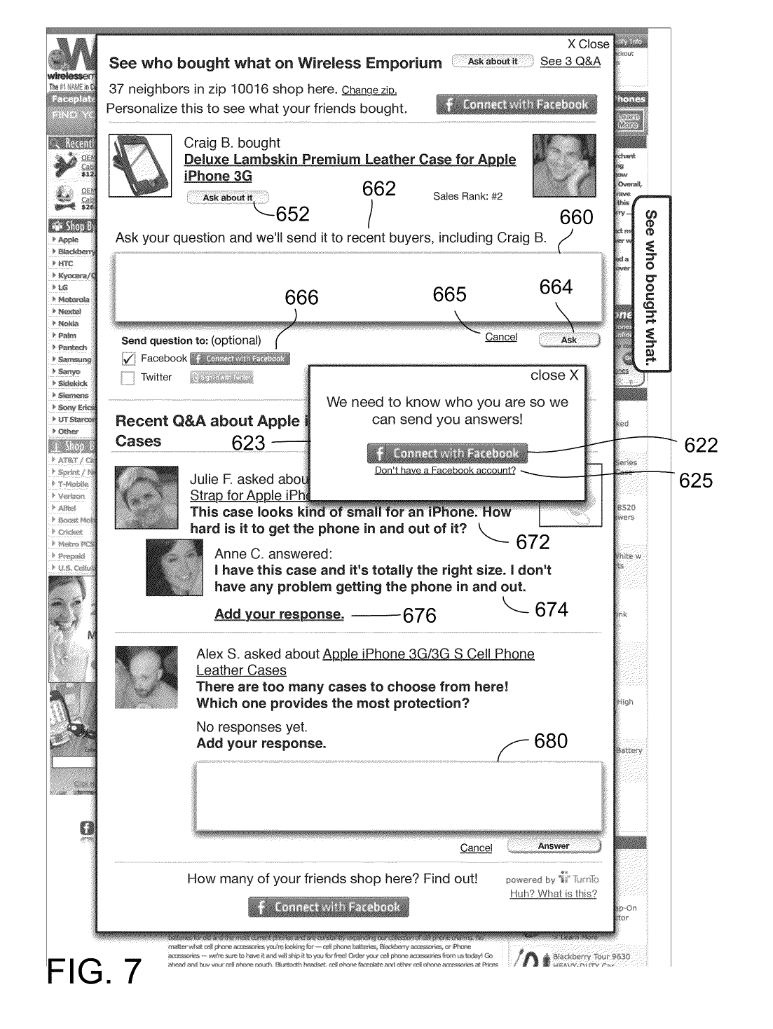

FIG. 7 illustrates that, when user invokes the “ask about it” button 652 in the first entry on figure E, a text entry box 660 opens and an instruction 662 is displayed. The user can then enter a question about the product, for example. If the user is satisfied with the typed question, she can click the “ask” button 664, and if not, the “cancel” link 665. An option 666 is provided to enable the user to have the question posed, not only to users of the current website who own the product, but also to friends of the user on one or more social networking sites. When the user invokes the Ask button 664, because the user in this example is not signed-up, i.e., un-registered, the overlay 668 opens, which asks the user to sign up at the Facebook site, by clicking on the button 622.

FIG. 7 also illustrates, in another entry 670, that Julie F. asked 672 about a product and that Anne C. answered the question 674 even though Julie F and Anne C are not then known to be contacts of the shopper. The shopper is given the opportunity to add a response 676. In a third entry 678, a question posed by Alex S. is displayed. The unregistered user has clicked on the add your response button to cause the text entry box 680 to open and await the user's text answer.

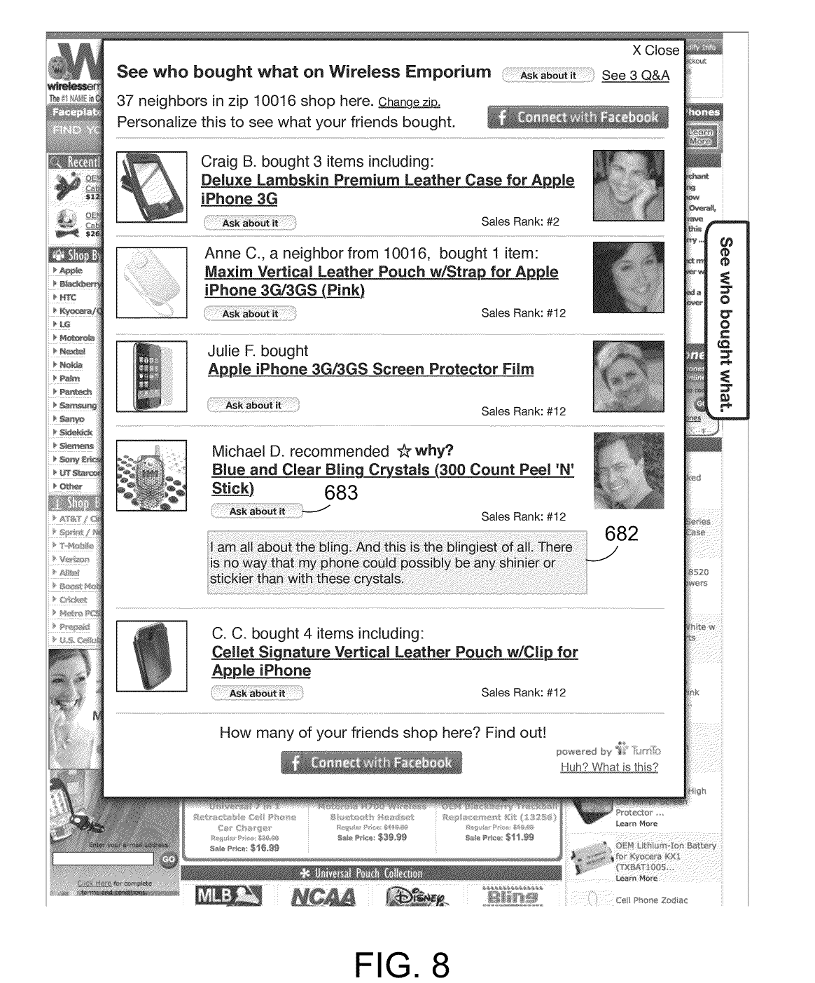

FIG. 8 illustrates the reason 682 given by Michael D for his recommendation of a product. The reason appears when the current user invokes the “ask about it” button 683 in that entry.

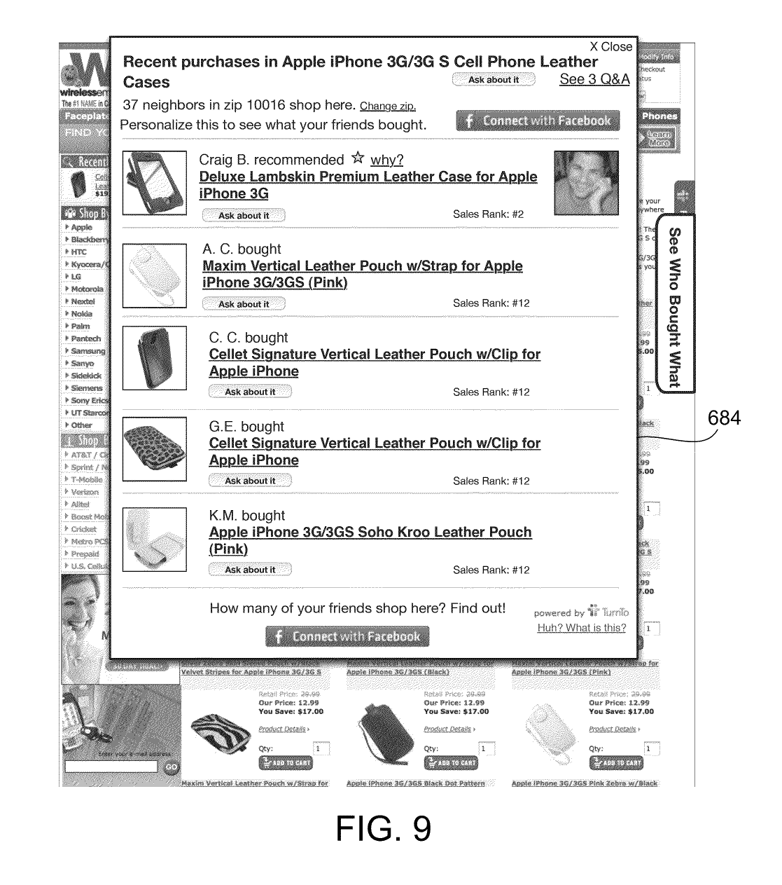

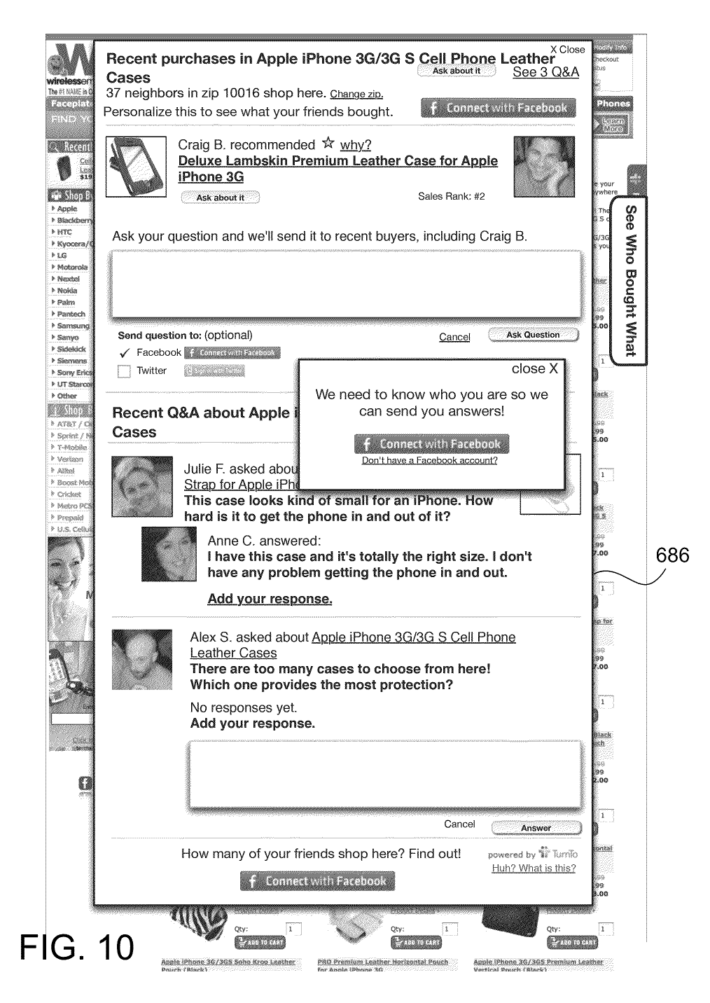

FIGS. 9 and 10 show overlays 684 and 686 that are similar to ones illustrated in earlier figures. Here, however, the entries displayed in each overlay have not been chosen with respect to available entries for the entire site, but with respect to a specified category of product (here Apple iPhone 3G/3GS cell phone leather cases), as indicated in the title of the overlay.

As shown for these overlays and others previously described, entries that report on people who recommended a product include a link “why?” That, when invoked, causes a display of the reason for that person's recommendation.

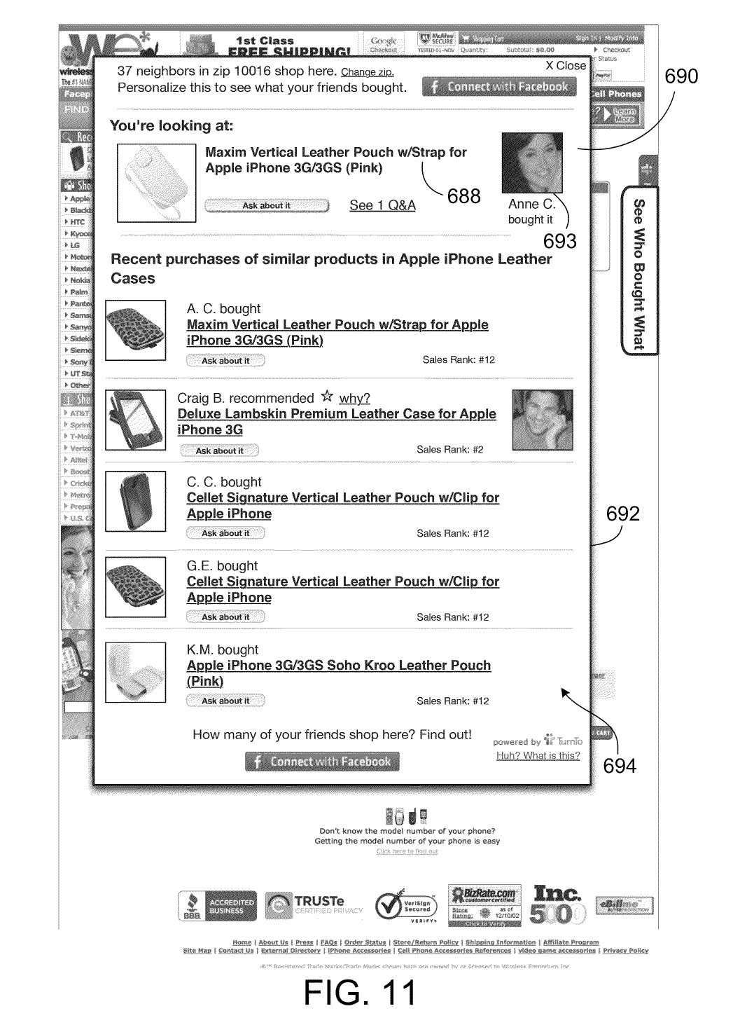

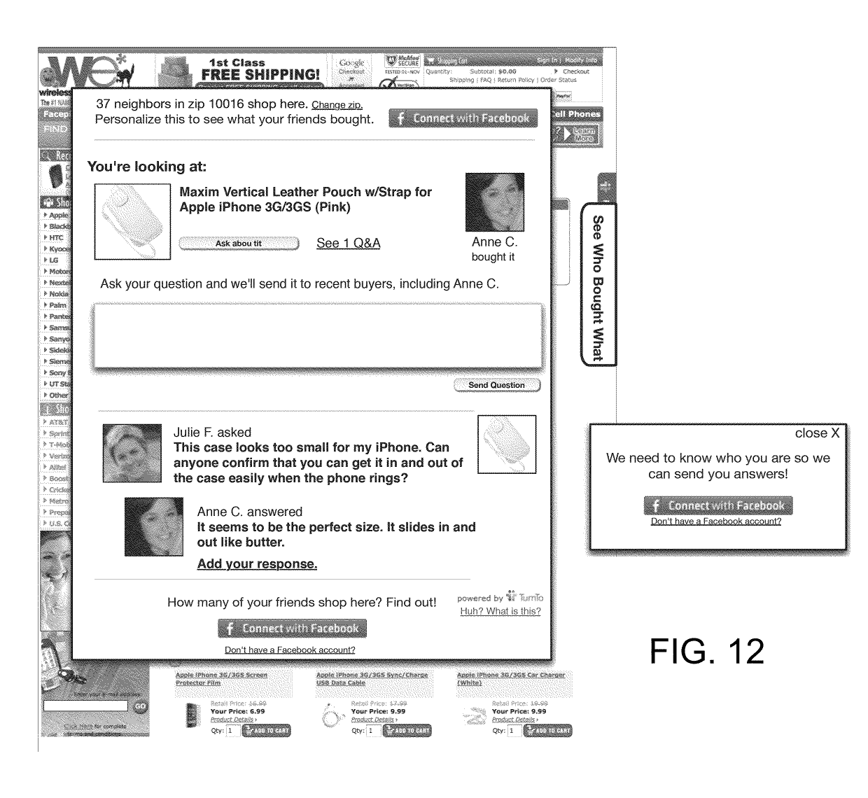

FIGS. 11 and 12 show similar overlays, but in this case the entries are focused on a specific product. The product is identified 688 in the top entry 690 of the overlay 692 on figure J. That entry also shows a thumbnail picture 693 of a person who bought the item. (Similar thumbnail images appear on entries shown on other figures.) Subsequent entries 694 of the overlay identify purchasers of similar products.

Note that in the figures discussed above, a shopper is given access to anonymous information about users who were purchasers of products at the site, without the system knowing that any of those purchasers is a contact or friend of the shopper.

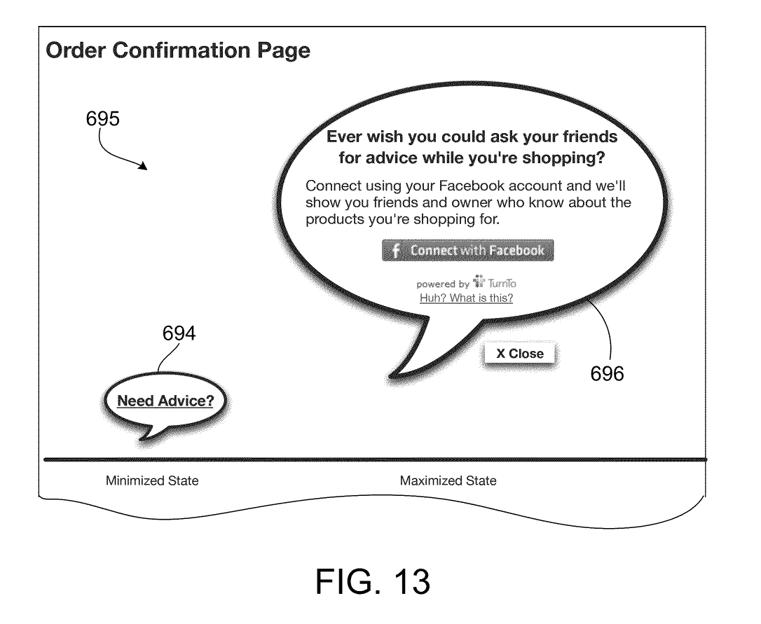

FIG. 13 illustrates the callout 695 that would be shown to an unregistered user on the order confirmation page for a product that the user bought. Initially, the callout would appear minimize 694. Clicking on the callout would enlarge it to the maximized state 696.

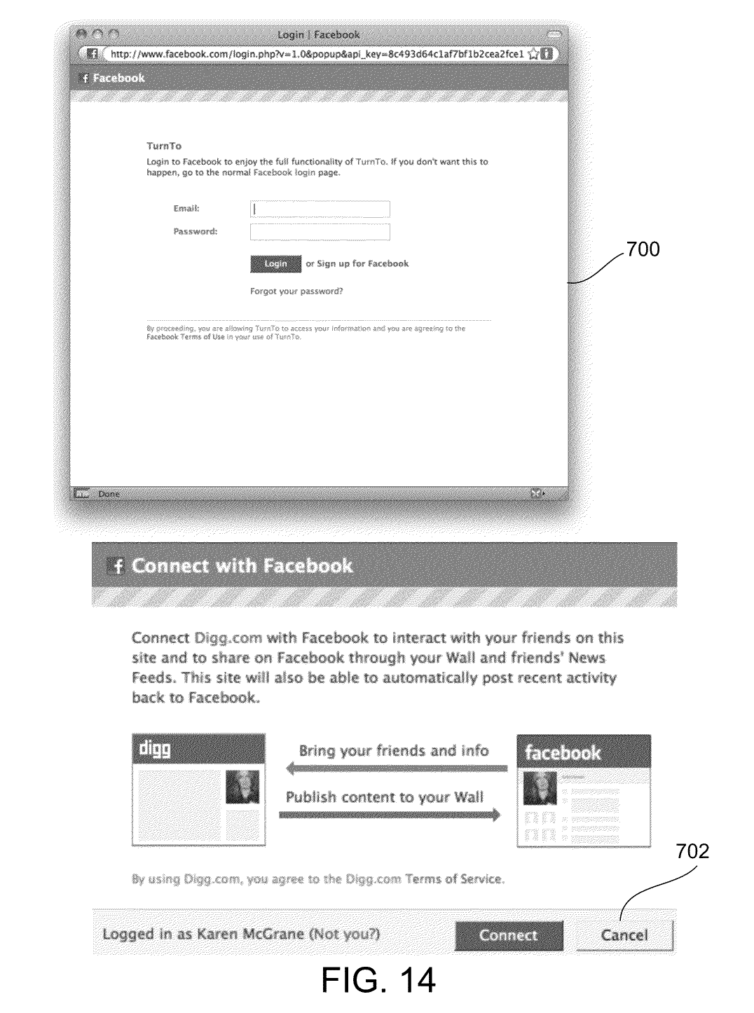

We turn now to the screens that are shown to the user during registration or sign up for the features being discussed above and below. The registration process is entered when the user invokes any of the “Connect with Facebook” links on any of the other screens. Invoking one of those links leads to the social networking site's login screen 700 on FIG. 14, where the user is invited to enter his email address and password for the social networking site. Depending on the source site from which the user reached the social networking site, invoking the registration process may lead instead to the login screen 702 on FIG. 14.

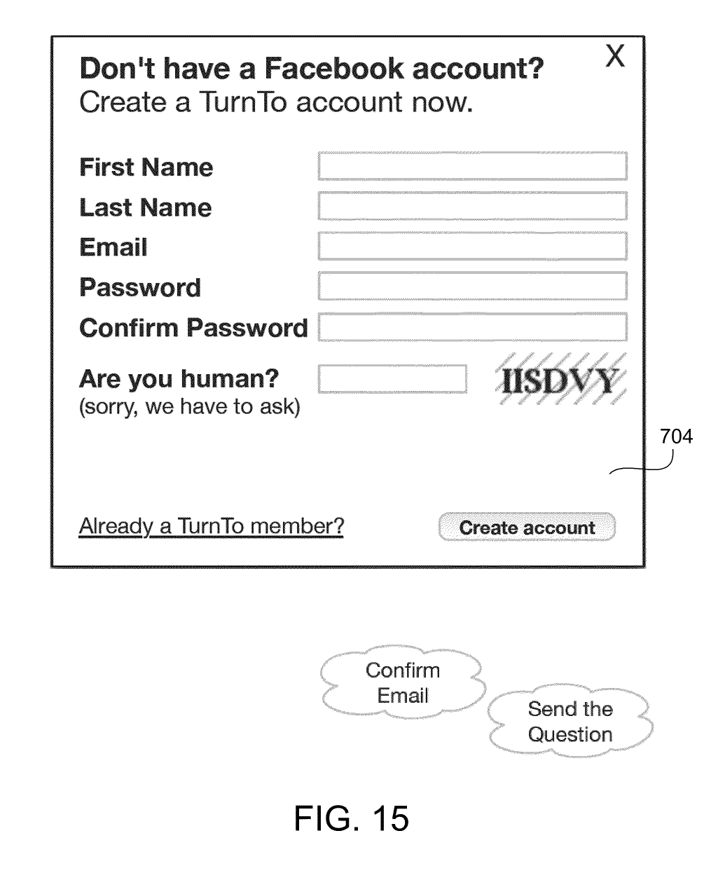

If the user does not have an account with the social networking site, an overlay 704 as shown in FIG. 15 is presented, enabling the unregistered user to create an account with the system host. Creating the account requires entering the user's name and email address. Creating the new account is beneficial to the social networking site, the registering user, the system host, and the site on which the shopper is active.

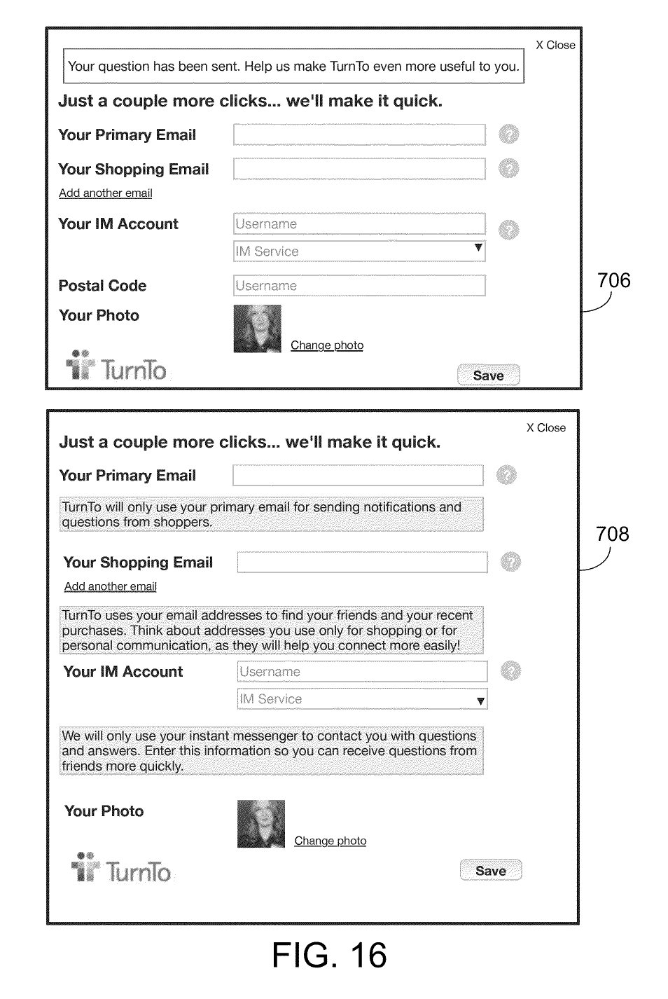

FIGS. 16, 17, 18, and 19 show forms that may be displayed during the course of registration flow, either as a widget overlay or embedded on a page on the affiliate site. When the user clicks on the social networking site connect button, he is first taken to the form shown in FIG. 14, then comes back to the form shown in FIG. 16. If the user registers in a traditional way, he starts with FIG. 15 instead of FIG. 14 and then goes on to FIG. 16.

When, for example, the ask link 664 on FIG. 7 is invoked, the overlay 623 will appear. If the user clicks on the button 622, then the dialog 700 of FIG. 14 appears. If the user clicks the “Don't have a FaceBook account?” link 625 on FIG. 7, the dialog of FIG. 15 appears. Becoming authenticated in this way is a less engaging step than signing up or becoming registered. In the overlay 706 of FIG. 16, the user enters email addresses and an instant messaging address, which can be used for sending questions to the user or sending replies to questions of the user. The user is also asked to provide a postal code which enables the system server to group people by location so that the transaction information may be selected to be more relevant to the user. The shopper can also add or change a photograph. The entered postal code can also used for the purpose of showing how many shoppers have a similar location to the user. The photograph thumbnail can be displayed in entries of overlays, as discussed earlier.

The overlay 708 is similar to the overlay 706, and shows information that is provided when help buttons are invoked.

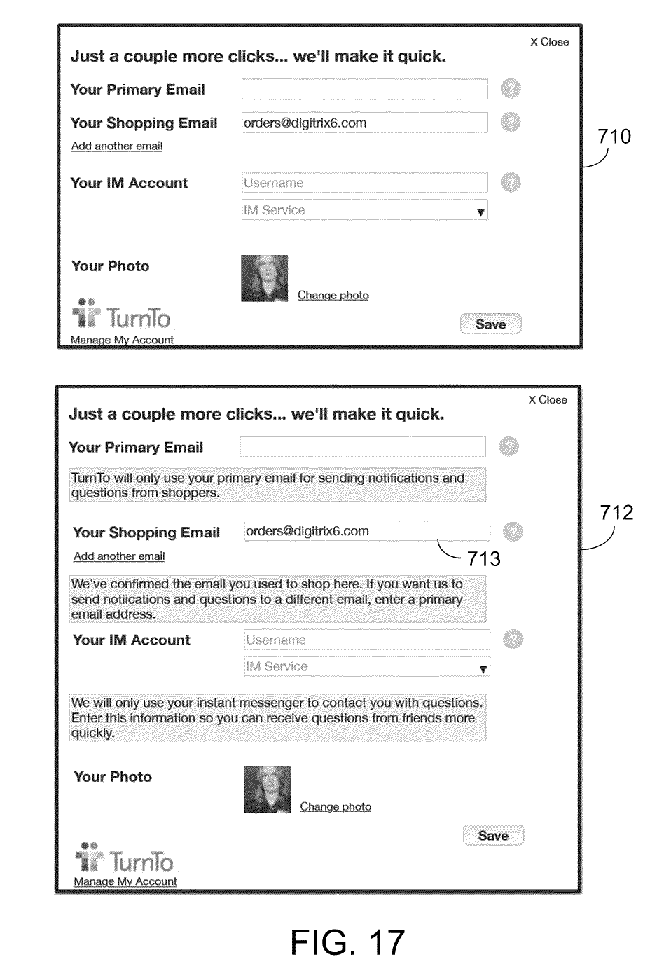

FIG. 17 shows that similar overlays 710, 712 are presented to the user immediately following a purchase on the site. In these cases, the shopping email of the user 713 is pre-completed from information already known to the site.

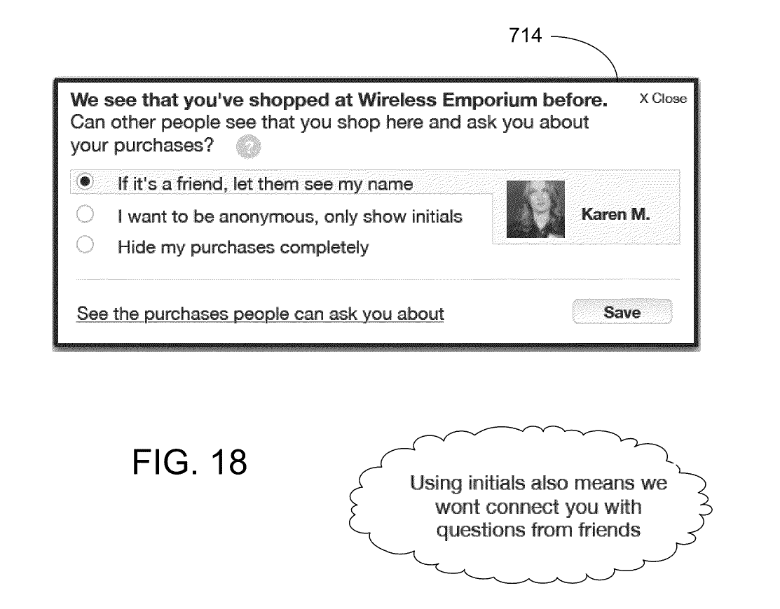

Once the user has completed the overlays of FIG. 17, the overlay 714 of FIG. 18 is presented. This overlay asks the user to permit display, to other users of the site, of the fact that he is a user of the site, and also to permit questions about his purchases to be posed to him. A set of radio buttons 716 enables the user to choose settings for this feature. This information provides the permissions necessary to allow at least some of the display features previously described, with respect to other users of the site, who are not participants in the host system.

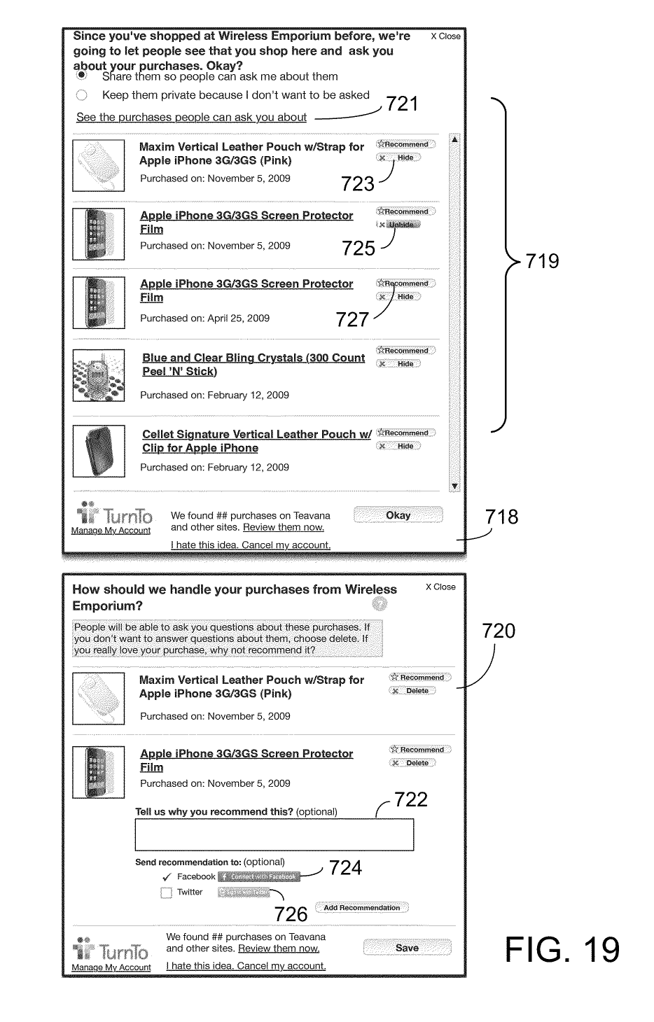

FIG. 19 shows an overlay 718 that contains entries 719 each of which corresponds to a prior purchase of the user. These entries appear when the link “see the purchases people can ask you about” 721 has been invoked. This enables the user to decide how to respond to the invitation to expose the information to others. In addition, toggling “hide” and “unhide” buttons 723, 725 enable the user to select which transactions to expose, for each transaction independently.

Each of the items on overlay 718 is accompanied by a “recommend” button 727. When the recommend button is invoked, the item for which the button was invoked is expanded to include a text entry box 722 on an overlay 720. The user can give a reason for his recommendation, which will then be displayed when other users request it, as described earlier. Additional links 724, 726 permit the user to send the recommendation to selected other social networking sites.

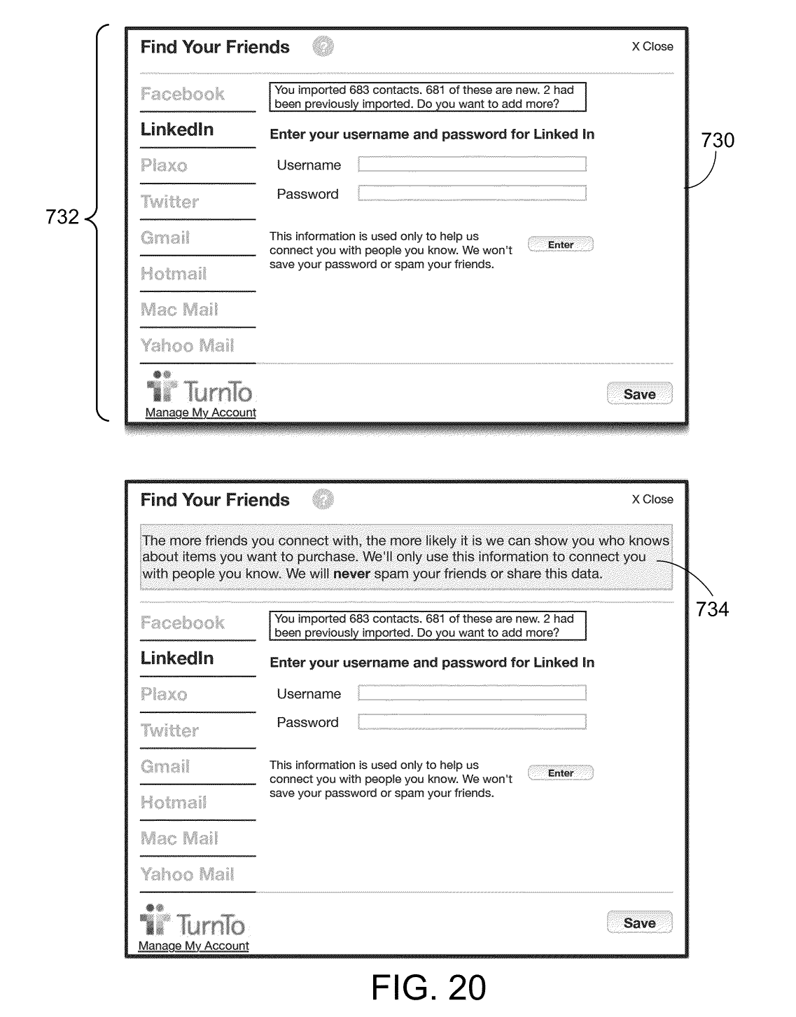

An overlay 730 shown on FIG. 20 encourages the user to find friends on other social networking and email sites 732 by entering his user name and password for each selected other site. A user confidence building message 734 is displayed when the user invokes the help button.

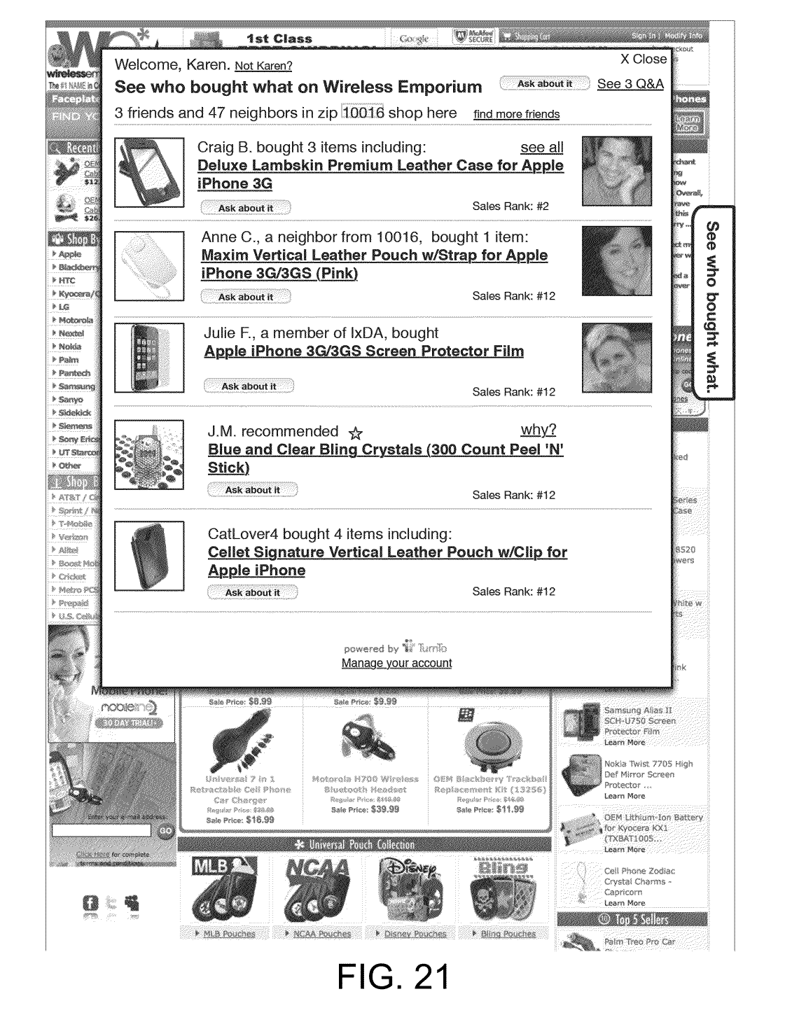

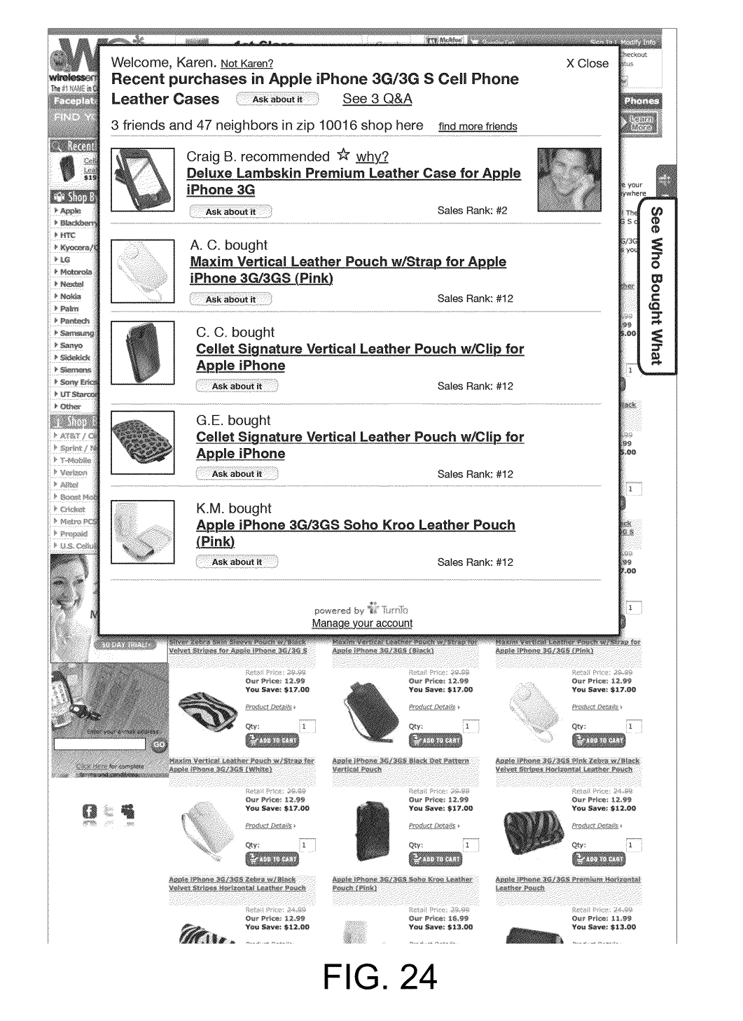

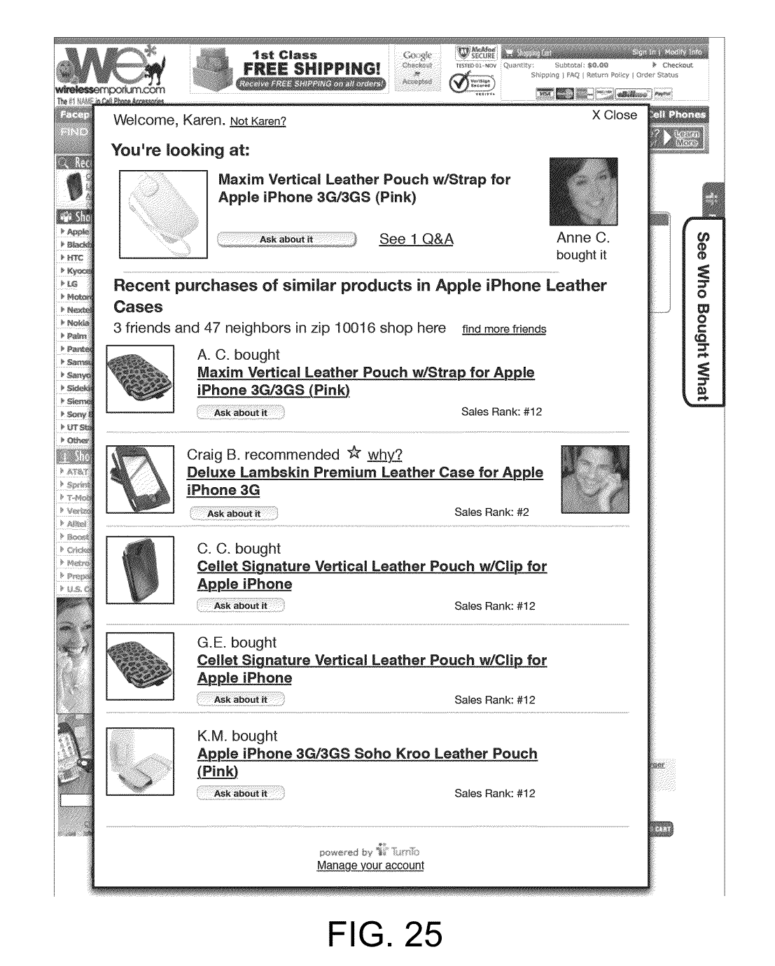

FIGS. 21 through 25 shows similar overlays that are presented to a user, once he has completed the registration process, at a site level (that is, with respect all related purchases made by other users of the site, FIGS. 21, 22, 23); at the category level (that is, with respect to purchases made by other users of the site same category of product, FIG. 24); and at the item level (that is with respect to purchases of exactly the same product by other users of the site, FIG. 25).

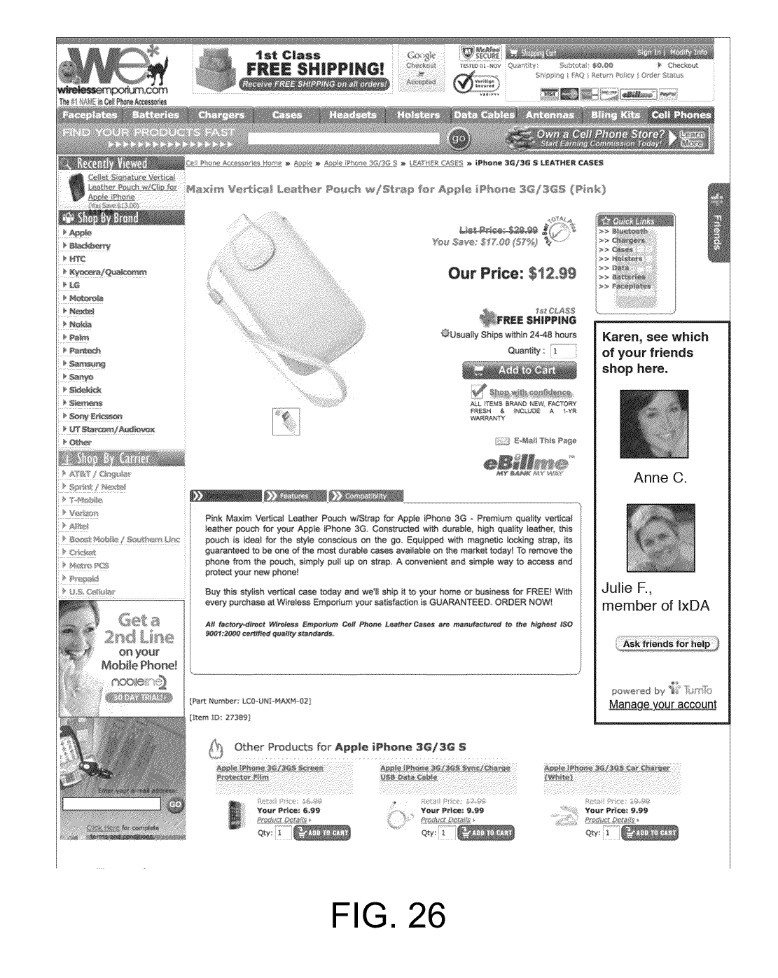

A sidebar 736 on FIG. 26 illustrates another way to display information about friends who use the same site without overlaying the main portion of the page.

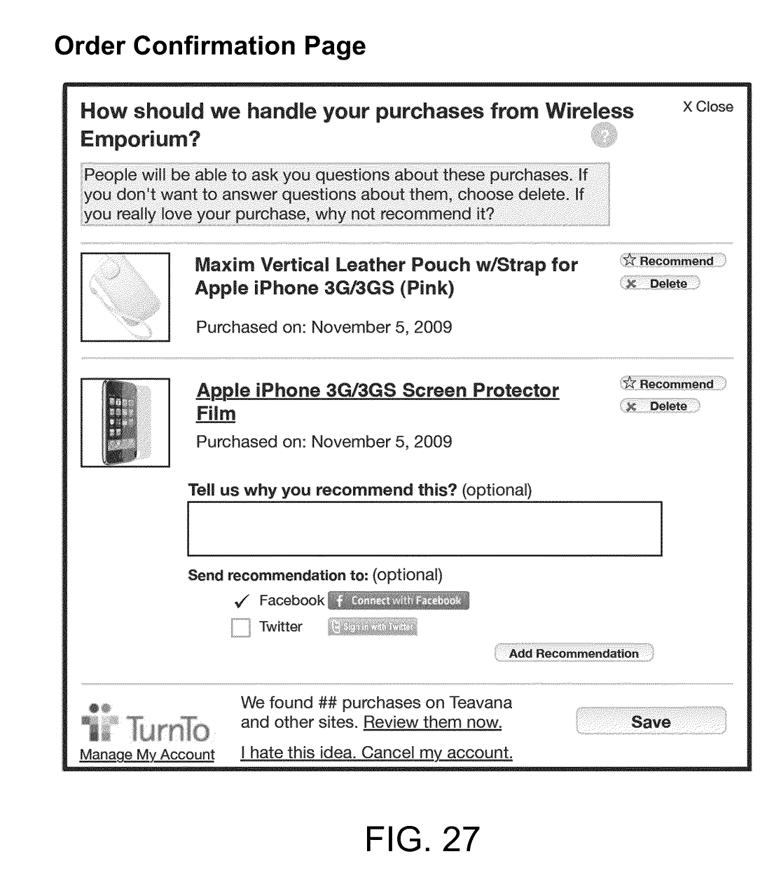

As shown in FIG. 27, the same overlay 720 of FIG. 19 can be shown as an overlay on the order confirmation page when a user makes a purchase. In this case, the initial display would be of a minimized control (not shown) that, when invoked, would open to the full form shown in FIG. 27.

A wide variety of other implementations are also within the scope of the claims.

1. A computer-implemented method comprising
exposing, to a user who is engaged in a commercial activity on a commercial online site, computer-stored information that (a) is associated with another user of the online site, (b) would otherwise be private to the other user, (c) relates to the commercial activity of the user, and (d) is controlled by the site.

2. The method of claim 1 in which the user who is engaged in the commercial activity and the other user are known to have a connection with one another.

3. The method of claim 1 in which the commercial activity includes shopping for a product or service.

4. The method of claim 1 in which the computer-stored information includes information about activities of the other user on the online site.

5. The method of claim 1 in which the computer-stored information includes information about a product or service bought by the other user on the site.

6. The method of claim 1 in which the computer-stored information comprises information about purchases at the site by users of the site.

7. The method of claim 1 in which the exposing of the user to the information includes facilitating an interaction between the user who is engaged in the commercial activity and the other user.

8. The method of claim 7 in which the facilitating of an interaction includes initially displaying some of the information without any information that is private to the other user.

9. The method of claim 7 in which the facilitating comprises serving as a conduit for a question of the user directed to the other user, and an answer of the other user.

10. The method of claim 7 in which the facilitating is assisted by a third party social networking system.

11. The method of claim 1 in which the information includes a recommendation of the other user.

12. The method of claim 1 in which the user and the other user are connected through a social networking site.

13. The method of claim 1 in which the connection of the user and the other user is determined by information provided by the user, the other user, or both.

14. The method of claim 1 in which the exposing includes identifying a connection between the user and the other user based on identifiers associated with at least one of the users, and selecting information to be exposed, based on the identified connection.

15. The method of claim 1 in which the other user has given permission to the exposing of the information to the user who is engaged in the commercial activity.

16. The method of claim 1 in which the information that is exposed to the user is a selected subset of available information that could be exposed to the user.

17. The method of claim 1 in which the information that is exposed is organized by a product item or a product category.

18. A computer-implemented method comprising
receiving an online inquiry from a user who is contemplating a transaction on an online site,
identifying one or more other users of the online site to whom to direct the inquiry, based on stored information about other transactions that have occurred on the online site.

19. The method of claim 18 also including: obtaining from the stored transaction information, data that enables the online inquiry to be sent to the other users.

20. The method of claim 18 in which the stored information about other transactions is controlled by the online site.

21. The method of claim 18 in which the online inquiry relates to a product that the user is contemplating buying, and at least some of the other transactions include transactions that relate to the product that the user is contemplating buying.

22. The method of claim 18 in which the user and the one or more other users are friends in a social networking system 23. The method of claim 18 also including getting a response to the inquiry from one or more of the other users, and exposing the responses to the user who is contemplating the transaction.
